(19) United States
(12) Patent Application Publication
(10) Pub. No.: US 2023/0040270 A1
(43) Pub. Date: Feb. 9, 2023

(54) VEHICULAR SIDE STRUCTURE

(71) Applicant: HONDA MOTOR CO., LTD., Tokyo (JP)

(72) Inventor: Shigeru WATANUKI, Wako-shi, Saitama (JP)

(21) Appl. No.: 17/786,224

(22) PCT Filed: Dec. 19, 2019
(86) PCT No.: PCT/JP2019/049965

§ 371 Date: Jun. 16, 2022

(51) Int. Cl. B62D 25/02; B62D 25/06; B62D 25/04

(52) U.S. Cl. CPC B62D 25/02; B62D 25/06; B62D 25/04

(57) ABSTRACT

A vehicular side structure includes: a side panel that is located above a door opening provided to a vehicle and forms an outer surface, wherein a ridge line is formed, along an upper edge of the door opening, in the side panel.

### TECHNICAL FIELD

The present invention relates to a vehicular side structure.

### BACKGROUND ART

The outer surface of a side part of a vehicle is generally formed using a side panel (also referred to as a “side outer panel”). The side panel has a door opening section formed therein where a door is arranged so as to be freely openable and closable (see, for example, Patent Literature 1).

In a double cab structure of a vehicle disclosed in Patent Literature 1, a side roof rail outer (14), a front pillar outer (11), a center pillar outer (12), and a rear pillar outer (13) are provided on an outer surface of a vehicle body side part. The side roof rail outer (14) is formed of a thin-plate member which has an arc shape when viewed in longitudinal section and extends in a front-rear direction above a door opening section.

### CITATION LIST

### Patent Literature

Patent Literature 1: JPH06-321131A (FIGS. 1 and 3)

### SUMMARY OF INVENTION

### Technical Problem

However, in the case of the shape of the side roof rail outer (14) as described in Patent Literature 1, the size of a member and the width in a vertical direction are emphasized, resulting in a rugged image. Depending on the type of vehicle, a slim looking exterior has recently been desired.

Since the side panel has the door opening section, there is room for improvement in stiffness of a vehicle body in an upper peripheral edge portion of the door opening section.

The present invention has been devised in view of the above-mentioned matters, and it is an object thereof to provide a vehicular side structure with which vehicle body stiffness of an upper peripheral edge portion of a door opening section can be improved.

### Solution to Problem

To solve the above problems, a vehicular side structure includes: a side panel that is located above a door opening provided to a vehicle and forms an outer surface, wherein a ridge line is formed, along an upper edge of the door opening, in the side panel.

### Advantageous Effects of Invention

According to the present invention, it is possible to provide a vehicular side structure with which vehicle body stiffness of an upper peripheral edge portion of a door opening section can be improved.

### BRIEF DESCRIPTION OF DRAWINGS

FIG. 1 is a schematic side view of a main part showing a vehicular side structure according to an embodiment of the present invention;

FIG. 2 is an enlarged schematic side view of a main part showing a front end portion of a ridge line in the vehicular side structure according to the embodiment of the present invention;

FIG. 3 is an enlarged schematic side view of a main part showing a rear end portion of the ridge line in the vehicular side structure according to the embodiment of the present invention; and

FIG. 4 is an enlarged cross-sectional view taken along a IV-IV line in FIG. 1.

### EMBODIMENTS OF THE INVENTION

Hereinafter, a vehicular side structure A according to an embodiment of the present invention will be described with reference to the drawings as appropriate. In the embodiment, it is assumed that “front” is the front side of a vehicle V, “rear” is the rear side of the vehicle V, “up” is the vertically upper side, “down” is the vertically lower side, and “right and left ” is the vehicle width direction. The same components are denoted by the same reference signs, and repetitive description will be omitted.

### <Vehicle>

First, prior to describing the vehicular side structure A according to the embodiment of the present invention, the vehicle V provided with the vehicular side structure A will be described.

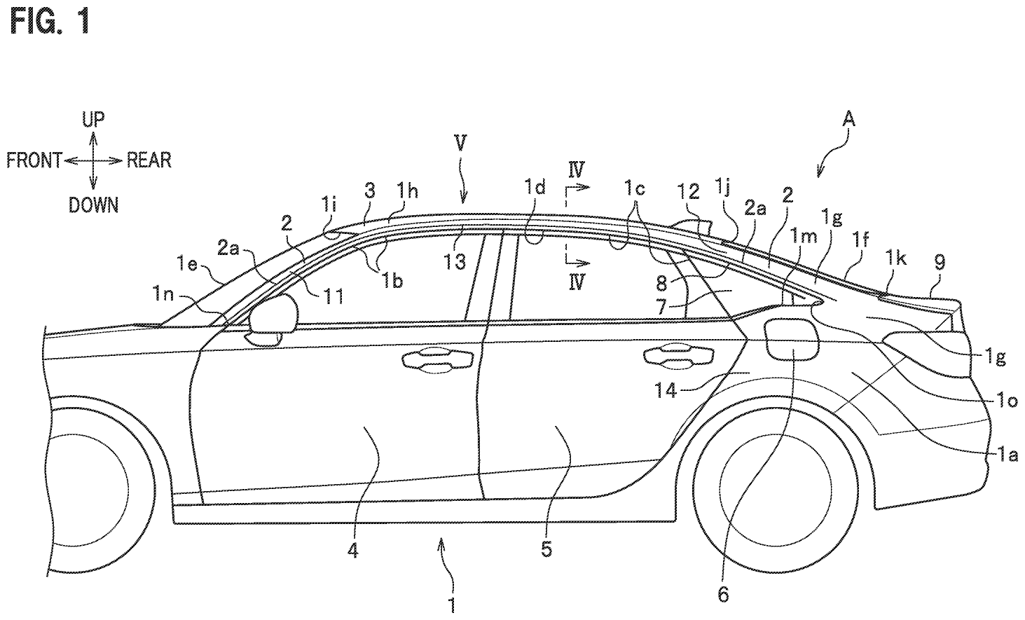

As shown in FIG. 1, the vehicle V is an automobile that includes a front door 4 and a rear door 5 on a vehicle body side part 1a, a side panel 2 above the front door 4 and the rear door 5 and the like, and a roof panel 3 on an outer upper surface 1h. The vehicle V is not particularly limited in type and shape. The vehicle V may be a 2-door type, a 3-door type, or a 4-door type. Hereinafter, the embodiment will be described as an example of the vehicle body side part 1a on the left side of a 4-door type passenger automobile having the front door 4, the rear door 5, and the like. Since the vehicular side structure A is formed substantially bisymmetrically, description of the driver's seat side (right side) will be omitted.

### <Vehicle Body Side Structure>

As shown in FIG. 1, the vehicular side structure A is directed to form the vehicle body side part 1a on either side of the vehicle body 1. The vehicular side structure A includes, for example, the side panel 2, the roof panel 3, the front door 4, the rear door 5, a fuel lid 6, a rear quarter window 7, and a molding member 8.

### <Side Panel>

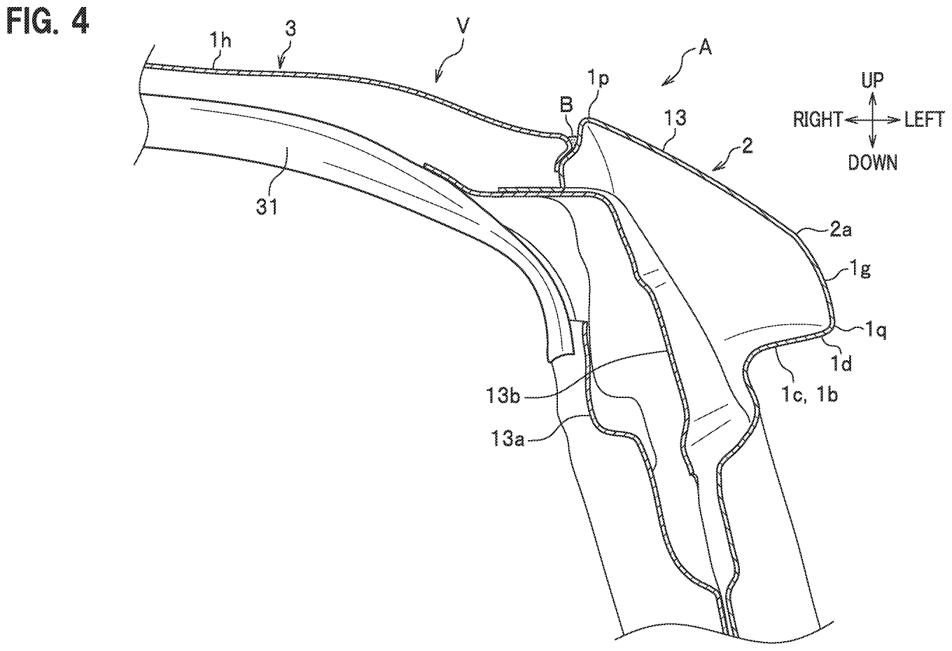

The side panel 2 is an outer panel member made of a high-strength steel plate or the like that forms an outer surface 1g of the vehicle body 1. In the side panel 2, a ridge line 2a, a front door opening section 1b (door opening), a rear door opening section 1c (door opening), a rear window glass opening section 1m, and the like are formed. The side panel 2 forms the outer surface 1g of a front pillar 11, a roof side rail 13, and a rear fender 14. The side panel 2 has its upper portion connected to the roof panel 3 (see FIG. 4).

### <Ridge Line>

FIG. 4 is an enlarged cross-sectional view taken along a IV-IV line in FIG. 1. The ridge line 2a is a ridge-shaped reinforcing portion formed by bending in a convex shape in a vehicle outward direction when viewed in longitudinal section (see FIG. 4) in order to reinforce the side panel 2. As shown in FIG. 4, the ridge line 2a is formed at a position closer to the door opening (front door opening section 1b and rear door opening section 1c) than the roof panel 3. On the front surface side of the front pillar 11, the roof side rail 13, and a rear pillar 12, an upper end ridge line 1p is extended in the front-rear direction at the upper end portion, and a lower end ridge line lq is extended in the front-rear direction at the lower end portion. The ridge line 2a is extended in the front-rear direction at a position closer to the lower end ridge line lq between the upper end ridge line 1p and the lower end ridge line 1q.

As shown in FIG. 1, the ridge line 2a is formed of a line extended substantially in the front-rear direction along upper edges 1d of the front and rear door opening sections 1b and 1c above the front and rear door opening sections 1b and 1c in the side panel 2. Therefore, the roof side rail 13 is reinforced by the ridge line 2a. The ridge line 2a thus formed has a function to make the exterior of the vehicle V look slim through optical illusion.

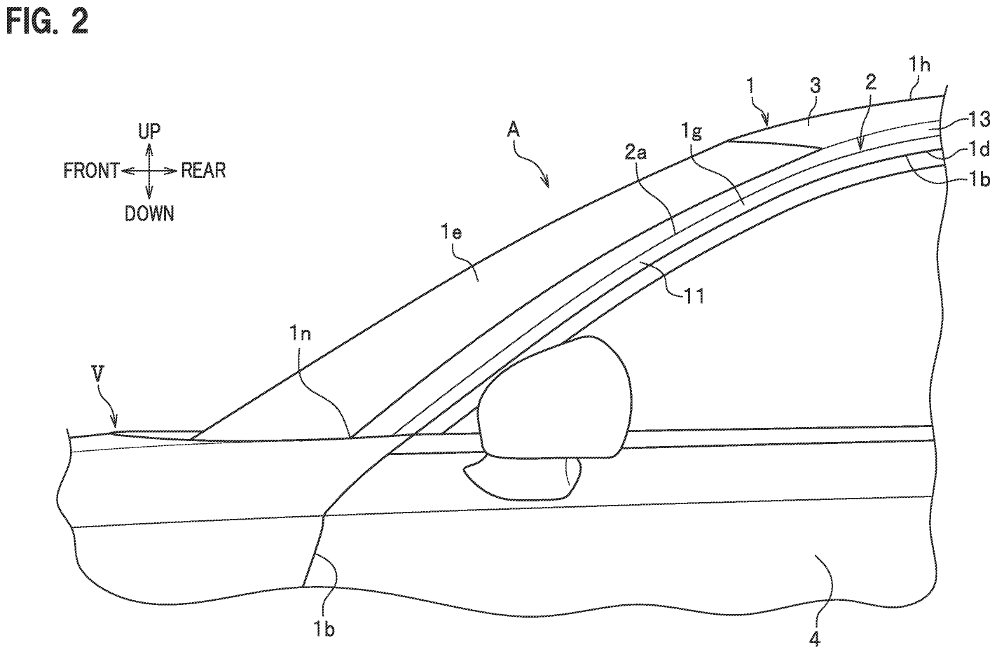

As shown in FIG. 2, the ridge line 2a is continuously formed from the upper edge 1d of the front door opening section 1b to at least a front end portion In of a window opening lower end of the front door 4 when viewed from the vehicle width direction. Therefore, the front pillar 11 is reinforced by the ridge line 2a.

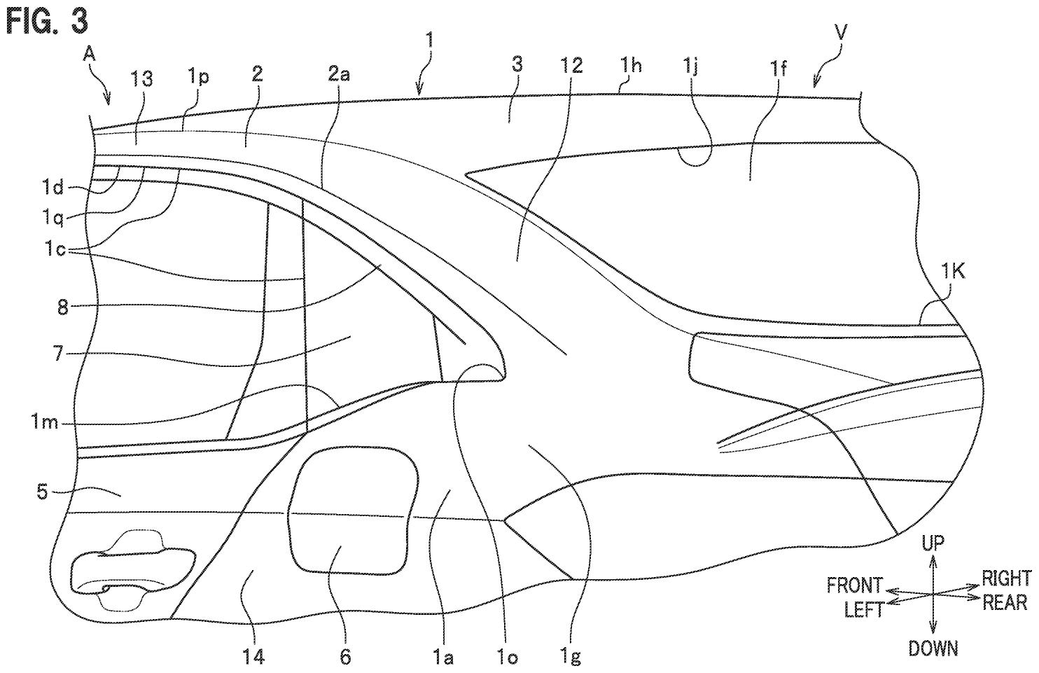

As shown in FIG. 3, the ridge line 2a is continuously formed from the upper edge 1d of the rear door opening section 1c to at least a rear end 1k of a rear opening 1j when viewed from the vehicle width direction. In other words, the ridge line 2a is continuously formed up to at least a rear end lo of the rear window glass opening section 1m of the vehicle body side part 1a when viewed from the vehicle width direction. Therefore, the rear pillar 12 is reinforced by the ridge line 2a.

### <Front Door Opening Section>

As shown in FIGS. 1 and 2, the front door opening section 1b is a door opening in which the front door 4 is arranged so as to be freely openable and closable. The outer surfaces of the upper edge 1d and the upper front side edge portion of the front door opening section 1b are formed by the side panel 2. The upper edge 1d (roof side rail 13) and the upper front side edge portion (front pillar 11) of the front door opening section 1b in the side panel 2 are reinforced by the ridge line 2a formed in the vicinity thereof.

### <Rear Door Opening Section>

As shown in FIGS. 1 and 3, the rear door opening section 1c is a door opening in which the rear door 5 is arranged so as to be freely openable and closable. The outer surface of the upper edge 1d of the rear door opening section 1c is formed by the side panel 2. The upper peripheral edge portion (roof side rail 13) of the rear door opening section 1c in the side panel 2 is reinforced by the ridge line 2a formed thereabove with a space.

### <Front Opening>

As shown in FIGS. 1 and 2, a front opening 1i is a window frame portion in which a windshield is installed. The front opening li is formed in a front surface 1e of a passenger compartment in the vehicle body 1. The front pillars 11 reinforced by the ridge line 2a are provided on both right and left sides of the front opening 1i.

### <Rear Opening>

As shown in FIGS. 1 and 3, a rear opening 1j is an opening portion (window frame portion) of a window in which a rear window glass is installed. The rear opening 1j is formed in a rear surface if of the passenger compartment in the vehicle body 1. The rear pillars 12 reinforced by the ridge line 2a are provided on both right and left sides of the rear opening 1j. The rear opening 1j is formed from the upper end portion to the lower end portion of the rear pillar 12 when viewed from the side. As shown in FIG. 1, a rear end 1k of the rear opening 1j is extended on the rear side of the vehicle body to a front end of a trunk lid 9 when viewed from the side. <Rear Window Glass Opening Section and Rear Quarter Window>

The rear window glass opening section 1m is a window frame portion to which the rear quarter window 7 is attached. The molding member 8 is attached to the upper edge portion and rear end portion of the rear window glass opening section 1m and also to the upper edges 1d of the front and rear door opening sections 1b and 1c. Therefore, the rear quarter window 7 is mounted on the upper edge 1d side of the rear window glass opening section 1m, with the molding member 8 interposed therebetween. The rear pillar 12 reinforced by the ridge line 2a is provided in the upper edge portion and rear end portion of the rear window glass opening section 1m.

The rear quarter window 7 may be made of resin or glass, and the material thereof is not particularly limited.

### <Molding Member>

As shown in FIGS. 1 and 3, the molding member 8 is a resin member extended in a substantially strip shape in the front-rear direction when viewed from the side. The molding member 8 is disposed from the front end portion In of the window opening lower end of the front door 4 to the rear end portion at the upper side edge of the rear window glass opening section 1m, having the upper edges 1d of the front and rear door opening sections 1b and 1c therebetween. The surface of the molding member 8 is plated.

### <Roof Side Rail>

As shown in FIG. 1 or 4, the roof side rail 13 is a metal structural member extended in the front-rear direction at the end portion in the left-right direction (vehicle width direction) and the upper end portion of the vehicle body 1. The roof side rail 13 includes the side panel 2 installed on the vehicle outer side, a roof side rail inner panel 13a installed on the vehicle outer side, and a stiffener 13b joined between the side panel 2 and the roof side rail inner panel 13a.

<Roof Panel>

As shown in FIG. 4, the roof panel 3 is a metal plate-shaped member that forms an outer upper surface 1h (ceiling surface) of the vehicle V. The roof panel 3 is arranged above a plurality of roof arches 31 provided at appropriate intervals between a pair of right and left roof side rails 13. The roof panel 3 and the side panel 2 (roof side rail 13) are fixed to each other by braze joining with use of blaze B.

### <<Effects of Vehicular Side Structure>>

Next, effects of the vehicular side structure A according to the embodiment of the present invention will be described with reference to the drawings.

As described above, in the vehicular side structure A according to the embodiment of the present invention, as shown in FIG. 1, the ridge line 2a is formed, along the upper edges 1d of the front and rear door opening sections 1b and 1c, in the side panel 2 that is located above the door opening (front door opening section 1b and rear door opening section 1c) provided in the vehicle V and forms the outer surface 1g.

According to the above configuration, the vehicular side structure A can improve vehicle body stiffness of the upper peripheral edge portion of the door opening section, reduced due to the formation of the front and rear door opening sections 1b and 1c, by forming the ridge line 2a. The vehicle V can make the side panel 2 look slim through optical illusion by forming the ridge line 2a along the upper edges 1d of the front and rear door opening sections 1b and 1c. The ridge line 2a allows the part from the front end portion of the front pillar 11 to the rear end portion of the rear pillar 12 via the roof side rail 13 to look thin, so that the entire exterior of the vehicle V can look slim.

As shown in FIG. 4, the vehicular side structure A has the roof panel 3 that forms the outer upper surface 1h of the vehicle V, the side panel 2 is connected to the roof panel 3, and the ridge line 2a is formed at a position closer to the door opening (front door opening section 1b and rear door opening section 1c) than the roof panel 3.

According to the above configuration, the vehicle V has the ridge line 2a formed along the upper edge 1d of the door opening at the position closer to the front door opening section 1b and the rear door opening section 1c than the roof panel 3. Therefore, the ridge line 2a allows the vehicle to have a sharp design so that a cabin space looks slim through optical illusion, as compared with a case where the ridge line 2a is arranged the other way around.

As shown in FIG. 4, the ridge line 2a is formed by the side panel 2 having a convex shape in the vehicle outward direction.

According to the above configuration, since the ridge line 2a of the side panel 2 is not convex in a vehicle inward direction, a sufficient space can be secured inside the vehicle. In a case where a strong external force is applied to the side panel 2 when the door is closed, the side panel 2 bends in the vehicle outward direction. Thus, a space can be secured inside the vehicle. In the roof side rail 13, the front pillar 11, and the rear pillar 12 where the side panel 2 is provided, the ridge line 2a has the convex shape in the vehicle outward direction. Therefore, the cross-sectional area is increased by the amount of protrusion, and thus the strength can be improved.

As shown in FIGS. 1 and 3, the vehicle V has the rear opening 1j on the rear surface if of the vehicle body 1, and the ridge line 2a is continuous at least up to the rear end 1k of the rear opening 1j when viewed from the vehicle width direction.

According to the above configuration, when viewed from the vehicle width direction, the ridge line 2a is formed, along the upper edge 1d of the door opening at the position near the front door opening section 1b and the rear door opening section 1c, at least up to the position where the rear opening 1j is provided. Therefore, the sense of slimness can be obtained by the side panel 2 that makes the width in the vertical direction look narrow through optical illusion. Since the ridge line 2a extends at least to the rear end 1k of the rear opening 1j, the ridge line 2a can be extended to the rear side beyond the rear end of the rear door opening section 1c to reinforce the upper edge 1d portion of the rear door opening section 1c. The side panel 2 can reinforce the vehicle body stiffness, reduced due to the formation of the rear door opening section 1c, by forming the ridge line 2a to increase the strength.

As shown in FIGS. 1 and 3, the ridge line 2a is continuous at least up to the rear end lo of the rear window glass opening section 1m of the vehicle body side part 1a when viewed from the vehicle width direction.

According to the above configuration, the side panel 2 can reinforce the vehicle body stiffness, reduced due to the formation of the rear window glass opening section lm, by forming the ridge line 2a at least up to the rear end lo of the rear window glass opening section 1m in the vehicle body side part 1a to increase the strength.

As shown in FIGS. 1 and 2, the ridge line 2a is continuous at least up to the front end portion 1n of the window opening lower end of the front door 4 when viewed from the vehicle width direction.

According to the above configuration, the sense of slimness can be obtained, that makes the width of the side panel 2 in the vertical direction look narrow through optical illusion, at least up to the position where the front end portion 1n of the window opening lower end of the front door 4 is arranged when viewed from the vehicle width direction. When viewed from the vehicle width direction, the vehicle body stiffness reduced due to the formation of the door opening (front door opening section 1b) can be reinforced by the ridge line 2a.

### Modification

Although the embodiment of the present invention has been described above, the present invention is not limited to the above embodiment and can be appropriately modified without departing from the scope of the invention.

For example, the description has been given as an example of the ridge line 2a having a convex shape in vehicle outward direction in the side panel 2 when viewed in longitudinal section as shown in FIG. 4. However, the present invention is not limited thereto. The ridge line 2a may be a ridge-shaped protrusion having a convex shape in the vehicle inward direction when viewed in longitudinal section. The ridge line 2a thus formed can also improve the strength of the side panel 2.

### REFERENCE SIGNS

1: vehicle body; 1a: vehicle body side part; 1b: front door opening section (door opening); 1c: rear door opening section (door opening); 1d: upper edge of door opening; 1f: rear surface of vehicle body; 1g: outer surface; 1h: outer upper surface of vehicle; 1j: rear opening; 1k: rear end of rear opening; 1m: rear window glass opening section; 1n: front end portion of window opening lower end of front door; 1o: rear end of rear window glass opening section; 2: side panel; 2a: ridge line; 3: roof panel; A: vehicular side structure; V:vehicle

1. A vehicular side structure comprising:
a side panel that is located above a door opening provided to a vehicle and forms an outer surface, wherein
a ridge line is formed, along an upper edge of the door opening, in the side panel.

2. The vehicular side structure according to claim 1, comprising:
a roof panel that forms an outer upper surface of the vehicle, wherein
the side panel is connected to the roof panel, and
the ridge line is formed at a position closer to the door opening than the roof panel.

3. The vehicular side structure according to claim 1, wherein the ridge line is formed by the side panel having a convex shape in a vehicle outward direction.

4. The vehicular side structure according to claim 1, wherein
the vehicle has a rear opening in a rear surface of a vehicle body, and
the ridge line is continuous at least up to a rear end of the rear opening when viewed from a vehicle width direction.

5. The vehicular side structure according to claim 1, wherein the ridge line is continuous at least up to a rear end of a rear window glass opening section of a vehicle body side part when viewed from the vehicle width direction.

6. The vehicular side structure according to claim 1, wherein the ridge line is continuous at least up to a front end portion of a window opening lower end of a front door when viewed from the vehicle width direction.
